(19) United States
(12) Patent Application Publication
(10) Pub. No.: US 2005/0164789 A1
(43) Pub. Date: Jul. 28, 2005

(54) Multi-screen video gaming system with private secondary monitors

(76) Inventors: Michael L. Nakamura, Crystal Lake, IL (US); George O. Podd, Lake Forest, IL (US); James D. Morrow, Oak Park, IL (US); Philip J. Siegel, Glencoe, IL (US)

Correspondence Address: Eric T. Krischke;Pauley Petersen & Erickson, Suite 365, 2800 West Higgins Road, Hoffman Estates, IL, 60195, US

(21) Appl. No.: 10/818,630

(22) Filed: Apr. 6, 2004

Related U.S. Application Data
(60) Provisional application No. 60/539,529, filed on Jan. 27, 2004.
(60) Provisional application No. 60/551,907, filed on Mar. 10, 2004.

(51) Int. Cl. A63F 13/00

(52) U.S. Cl. 463/36

(57) ABSTRACT

A video gaming system including a primary monitor having a first screen for displaying at least one community video graphic. A portable game module is operatively connected to the primary monitor. The video gaming system also includes a plurality of hand controllers. Each hand controller is in independent operational communication with the game module, and includes a secondary monitor for displaying at least one private video graphic. In one preferred embodiment of this invention, each hand controller includes a cloaking device activatable to reveal the at least one private video graphic.

### CROSS REFERENCE TO RELATED APPLICATIONS

This application claims the benefit of U.S. Provisional Application No. 60/539,529, filed 27 Jan. 2004, and the benefit of U.S. Provisional Application No. 60/551,907, filed 10 Mar. 2004.

### BACKGROUND OF THE INVENTION

1. Field of the Invention

This invention relates generally to a multi-screen video gaming system and, more particularly, to a multi-screen video gaming system for playing video card games in a closed or contained environment.

2. Discussion of Related Art

Electronic game systems have gained wide-spread popularity. Many electronic game systems include a gaming device that is electrically connected to a television. A hand controller plugs into the gaming device to communicate with the gaming device to play a selected video game. However, these conventional gaming devices do not allow more than one player to interactively play electronic video games in a closed video format, wherein every player can view a community visual graphic and each player can view a private video graphic, for example while playing certain card games.

There is a need for a multi-screen video gaming system to solve problems associated with playing certain video games, such as card games, in a closed video format with more than one player.

### SUMMARY OF THE INVENTION

One object of this invention is to provide an improved video gaming system.

Another object of this invention is to provide a multi-screen video gaming system for playing video card games, which displays community cards on a primary monitor and each player's individual or private hand of cards on an independent secondary monitor.

Another object of this invention is to provide a video gaming system that can be reconfigured, tailored or adapted to play various video games.

Still another object of this invention is to provide a video gaming system for playing video card games that is compatible with existing video gaming systems.

The above and other objects of the invention can be attained through a video gaming system including a primary monitor having a first screen for displaying at least one community video graphic. A portable game module is operatively connected to the primary monitor. Each hand controller of a plurality of hand controllers is in independent operational communication with the game module, and includes a secondary monitor for displaying or revealing at least one private video graphic.

The prior art generally fails to provide a video gaming system that allows more than one player to interactively play electronic video games in a closed video format, wherein every player can view a community visual graphic and each player can view a private video graphic, for example while playing certain card games.

The invention further comprehends a video gaming system including a primary monitor for displaying at least one community video graphic, the video gaming system including a portable game module operatively connected to the primary monitor, and a plurality of hand controllers. Each hand controller is in independent operational communication with the game module, and includes a secondary monitor for displaying or revealing at least one private video graphic, wherein each hand controller includes a cloaking device that is activatable to reveal the at least one private video graphic.

The invention still further comprehends a video gaming system including a primary monitor having a first screen for displaying at least one community video graphic. A portable game module is operatively connected to the primary monitor. Each hand controller of a plurality of hand controllers is in independent operational communication with the game module. Each hand controller includes a secondary monitor for displaying or revealing at least one private video graphic, a cloaking device activatable to reveal the at least one private video graphic and a plurality of command buttons, each command button selectable to transmit a command to the game module.

The invention provides a multi-screen video gaming system, which allows players to enjoy the actual “live” card game experience that comes with “bluffing” or “hidden hands,” for example in card games such as Poker.

Other objects and advantages of the invention are apparent to those skilled in the art, in view of the following detailed description taken in conjunction with the appended claims and drawings.

### BRIEF DESCRIPTION OF THE DRAWINGS

FIG. 1 is a perspective view of a multi-screen video gaming system including a plurality of independent hand controllers in operational communication with a game module, according to one preferred embodiment of this invention;

FIG. 2 is a perspective view of a multi-screen video gaming system including a plurality of wireless independent hand controllers in operational communication with a game module, according to one preferred embodiment of this invention;

FIG. 3 is a perspective view of a multi-screen video gaming system connected to an existing video gaming system platform, and including a plurality of independent hand controllers in operational communication with a game module, according to one preferred embodiment of this invention;

FIG. 4 is a top view of a game module, according to one preferred embodiment of this invention;

FIG. 5 is a front view of the game module shown in FIG. 4;

FIG. 6 is a bottom view of the game module shown in FIG. 4;

FIG. 7 is a perspective view of a hand controller including a secondary monitor, according to one preferred embodiment of this invention;

FIG. 8 is a perspective view of a hand controller including a secondary monitor, according to one preferred embodiment of this invention;

FIG. 9 is a perspective view of a hand controller including a secondary monitor, according to one preferred embodiment of this invention;

FIG. 10 is a perspective view of a hand controller including a secondary monitor, according to one preferred embodiment of this invention;

FIG. 11 is a front view of a hand controller including a secondary monitor, according to one preferred embodiment of this invention;

FIG. 12 is a top view of the hand controller shown in FIG. 11;

FIG. 13 is a side view of the hand controller shown in FIG. 11;

FIG. 14 is a back view of the hand controller shown in FIG. 11;

FIG. 15 illustrates a visual graphic displayed on a primary monitor screen, according to one preferred embodiment of this invention;

FIG. 16 illustrates a visual graphic displayed on a primary monitor screen, according to one preferred embodiment of this invention;

FIG. 17 illustrates a visual graphic displayed on a primary monitor screen, according to one preferred embodiment of this invention; and

FIG. 18 illustrates a visual graphic displayed on a primary monitor screen, according to one preferred embodiment of this invention.

### DETAILED DESCRIPTION OF THE INVENTION

The present invention provides a multi-screen video gaming system 10 for playing video games in a closed or contained environment. The following description of this invention describes or relates to playing video card games with the multi-screen video gaming system 10. However, the multi-screen video gaming system 10 according to preferred embodiments of this invention can be used to play any suitable video game including, but not limited to, casino games, sporting games such as football, baseball, basketball, hockey and soccer, action games, and arcade games. The multi-screen video gaming system 10 according to this invention, including any component or equipment piece such as the primary monitor 20, the game module 30 and the independent hand controllers 40, or any graphics displayed on the primary monitor and/or the secondary monitors, may be tailored to suit any card game, such as Poker, Go Fish, Crazy Eights, Gin Rummy and Blackjack.

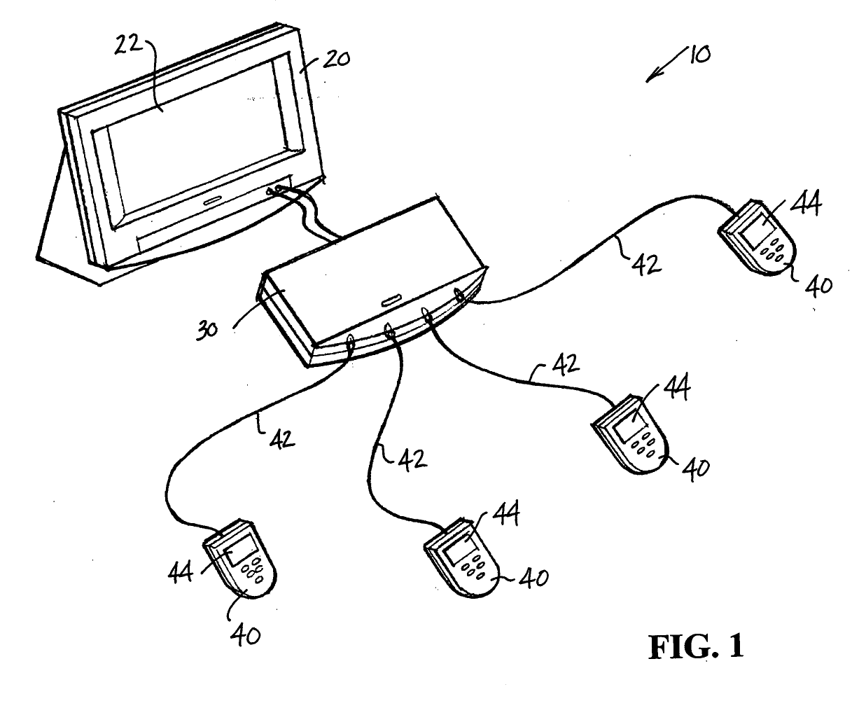

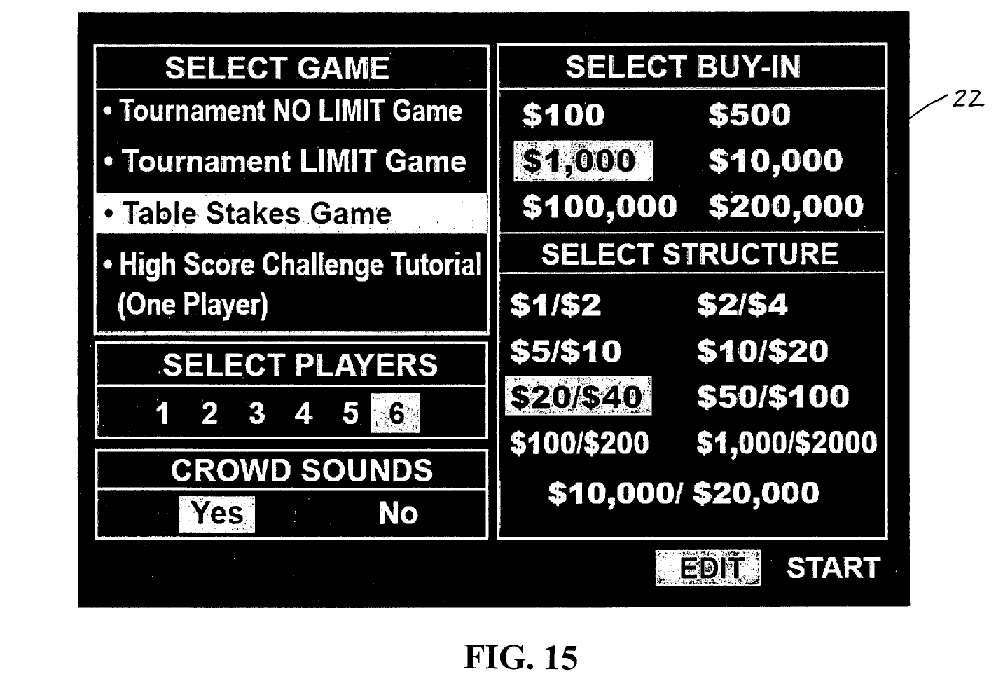

Referring to FIGS. 1-3, in one preferred embodiment of this invention, the multi-screen video gaming system 10 includes a primary monitor 20. The primary monitor 20 comprises a first screen 22 for displaying at least one community video graphic. The primary monitor 20 may comprise a conventional television, a computer monitor, plasma screen or any other suitable screen or monitor that will display to the players a common group or community card visual. Referring further to FIGS. 15-18, the primary monitor 20 may display visual graphics to assist or instruct the players and/or provide added entertainment during game play.

For example, the primary monitor 20 may visually display a game set screen as shown in FIG. 15, to instruct the players to choose or select a game to play and enter or select game options, variations and/or settings. The game set screen as shown in FIG. 15 is formatted specifically for a “Texas Hold ‘Em” poker game, wherein the players can choose or select the desired game, the number of players, sound effect options, and desired game rules and betting structures. In one preferred embodiment of this invention, any suitable card game can be selected from a list of available games displayed on the primary monitor 20, such as Poker, Gin Rummy, Go Fish, Crazy Eights and Blackjack. It is apparent to those skilled in the art and guided by the teachings herein provided that the game set screen can be modified to correspond with any selected or desired game.

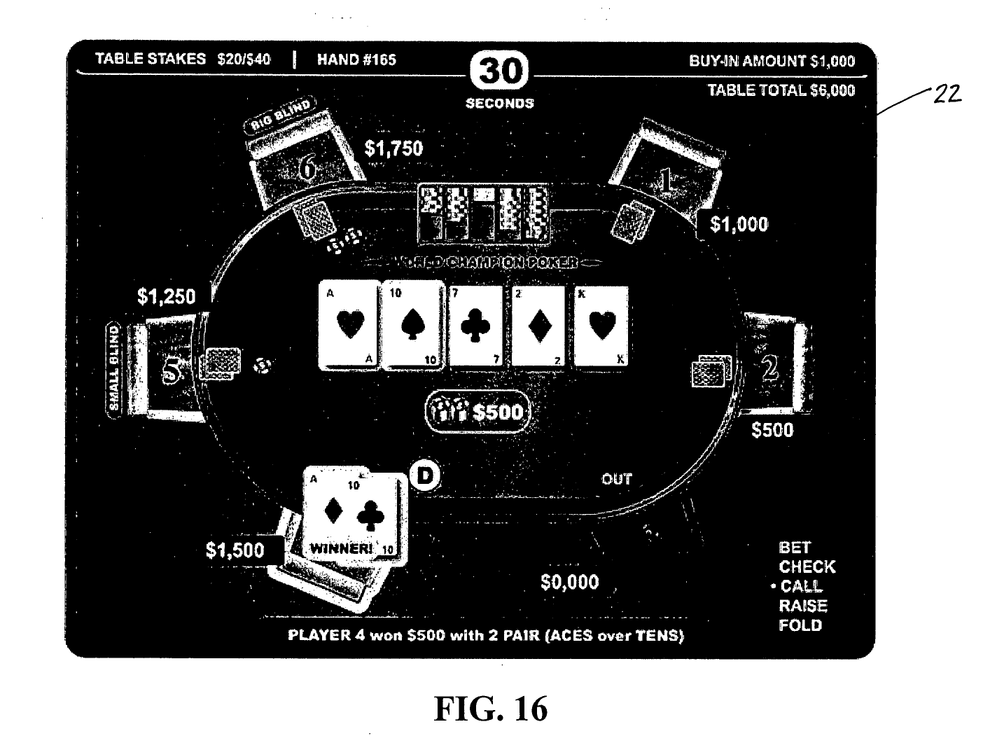

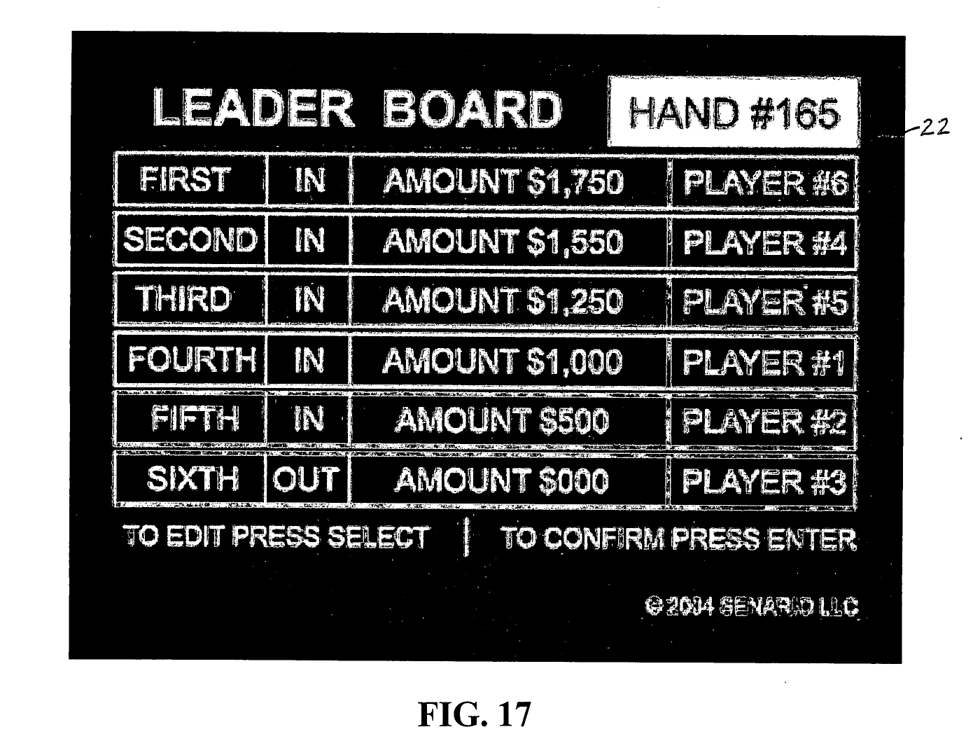

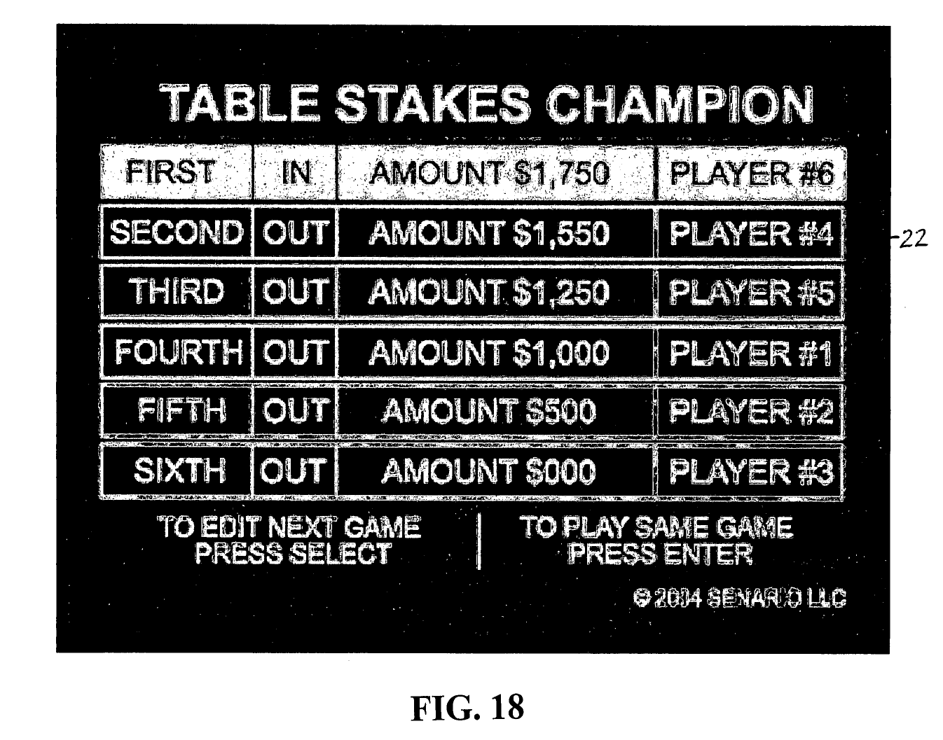

During game play, the primary monitor 20 may display community visual graphics, such as shown in FIG. 16 so that each player can view the game as the game proceeds. As shown in FIG. 16, the primary monitor 20 may visually display a casino-type playing table with a number of playing cards positioned on the playing table corresponding to the number of players participating in the game and according to the rules and/or procedures of the selected card game. The primary monitor 20 may display a “virtual” dealer, players, scores, a timer, a bank, casino chips and a table setting, as well as any other suitable or conceivable video graphics. The primary monitor 20 may also temporarily and/or at selected or programmed intervals, display a game leader board as shown in FIG. 17, for example after a hand has been played, and may display the table stakes game champion at the end of the game, as shown in FIG. 18.

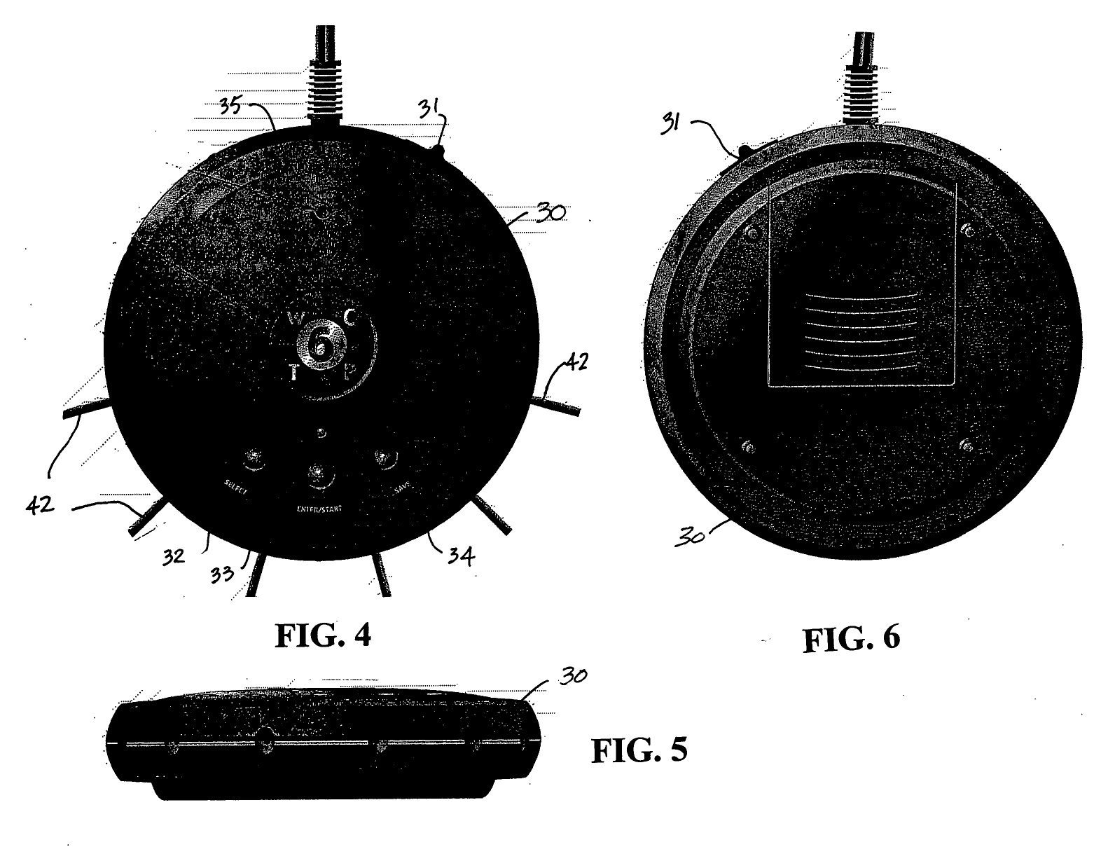

The multi-screen video gaming system 10 preferably comprises a self-contained and independent game module 30, which interfaces with the primary monitor 20 and each hand controller 40, as shown in FIGS. 1-3, to link or connect each hand controller 40 to the primary monitor 20 to provide communication therebetween and/or allow each player to control his or her game play. In one preferred embodiment of this invention, the game module 30 is portable so that the multi-screen video gaming system 10 can be transported and played using any suitable or available primary monitor 20. As shown in FIGS. 4-6, the game module 30 can be relatively small to make the multi-screen video gaming system 10 easily portable. Further, because the game module 30 is self-contained, the multi-screen video gaming system 10 can be used without the need for a network system, such as an intranet or internet connection.

In one preferred embodiment of this invention, the game module 30 is in electrical and/or operational control communication with the primary monitor 20. The game module 30 transmits at least one signal to generate the at least one community video graphic displayed on the first screen 22. The game module 30 can be operatively connected to the primary monitor 20 using any suitable connections, such as cables or wires, infrared (IR) technology, radio control (RC) technology, and/or a suitable wireless data transfer technology such as BLUETOOTH technology. In one preferred embodiment of this invention, the multi-screen video gaming system 10 can be used to play any number of different games. For example, the game module 30 may include a port (not shown) which accepts or receives software, such as video game cartridges or discs for example, for playing a selected video game. It is apparent to those skilled in the art and guided by the teachings herein provided that the game module 30 may include any suitable compatible game port for playing any suitable game cartridge or disc. In one preferred embodiment of this invention, the game module 30 may include a USB port or any suitable connecting element or device for downloading video games from a computer and/or the internet, for example. Further, as shown in FIG. 4, the game module 30 may include any suitable system control switches and/or buttons, such as a power switch 31, a game select button 32, an enter/start button 33, a save button 34 and a reset button 35.

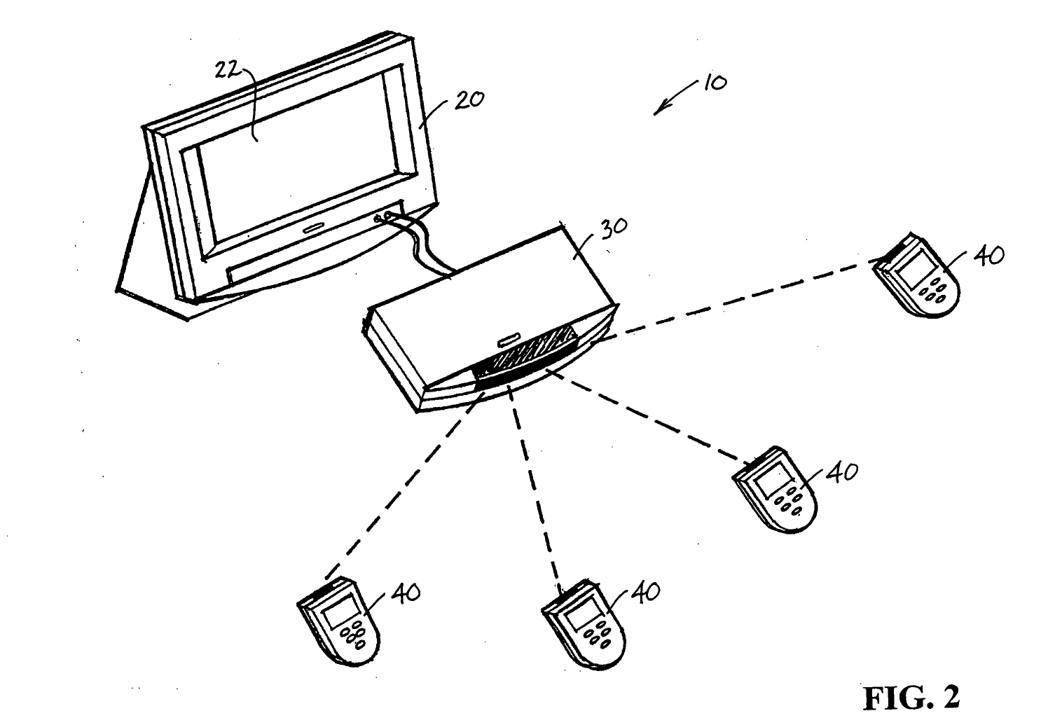

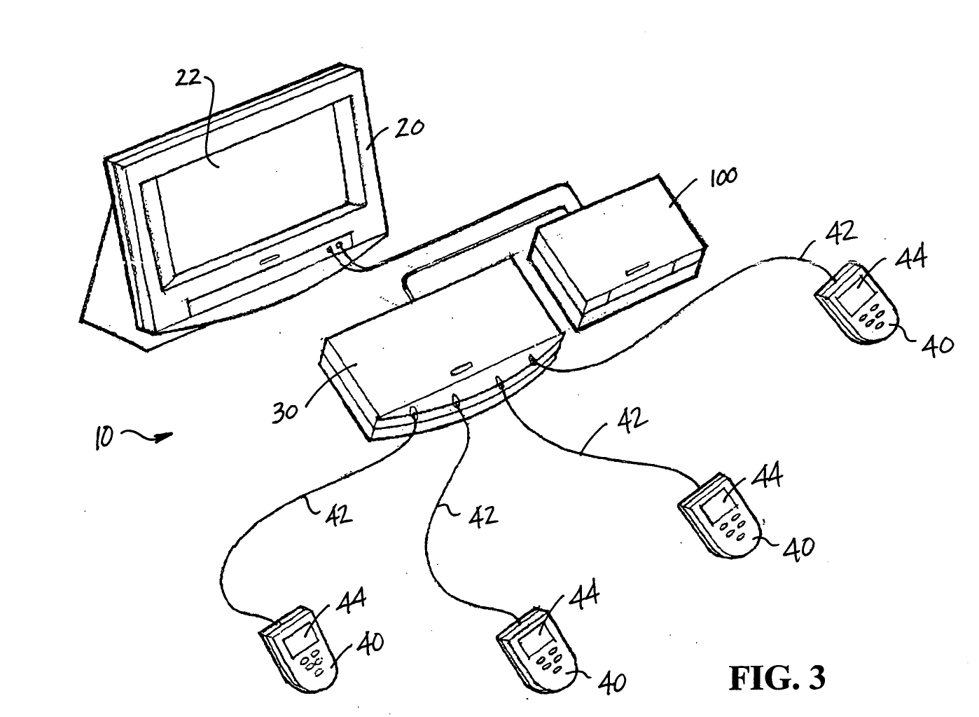

Preferably, a plurality of independent hand controllers 40 are in independent electrical and/or operational communication with the game module 30. Additionally, in certain preferred embodiments of this invention, each hand controller 40 may communicate with the other hand controllers 40 during game play. The multi-screen video gaming system 10 may be used with one or more players, preferably 2 to 6 players. Independent or individual hand controllers 40 can be turned on and off, depending on how each card game is played and the number of players playing the selected card game. Each hand controller 40 is independently operationally connected to the game module 30 using a suitable cable or wire 42 for example, as shown in FIGS. 1 and 3, or each hand controller 40 can be in wireless operational communication with the game module 30, as shown in FIG. 2. The term “operational communication” refers to the user's or player's ability to transmit a command signal to the game module 30 using the player's hand controller 40 to select a move or make a decision while playing the video game and receive transmitted signals from the game module 30. The game module 30 processes the command signal to initiate a responsive or corresponding action. The responsive action and/or a result of the responsive action can then be displayed on the primary monitor 20.

As shown in FIG. 1, in one preferred embodiment of this invention, the multi-screen video gaming system 10 includes a plurality of hand controllers 40 each independently wired to the game module 30. For example, each hand controller 40 is wired to the game module 30 and the game module 30 is wired to the primary monitor 20. Each component can be wired to one or more associated components using any suitable connector, such as a standard cable, wire,jack or plug connect. For example, each hand controller 40 may be independently operationally connected to the game module 30 using a suitable cable or wire 42, which includes an electrical plug or mating element that is detachable with respect to the game module 30, for example when the hand controller 40 is not being used to play the game. Alternatively, at least one of the hand controllers 40 may be wired into or otherwise permanently electrically connected to the game module 30, using any suitable electrical connection known in the art.

As shown in FIG. 2, in one preferred embodiment of this invention, the multi-screen video gaming system 10 is semi-wireless. The term “semi-wireless” refers to a system set-up wherein each hand controller 40 sends at least one wireless signal, such as an infrared (IR) signal, a radio control (RC) signal, a suitable wireless data transfer signal such as a BLUETOOTH technology signal and/or any other suitable method signal, to the game module 30 and the game module 30 is wired to the primary monitor 20 using suitable cables or wires. Alternatively, in one preferred embodiment of this invention, each hand controller 40 is wired to the game module 30 and sends at least one wired signal to the game module 30 and the game module 30 can send at least one wireless signal, such as an infrared (IR) signal, a radio control (RC) signal, a suitable wireless data transfer signal such as a BLUETOOTH technology signal and/or any other suitable method signal, to the primary monitor 20.

In one preferred embodiment of this invention, the multi-screen video gaming system 10 is wireless. The term “wireless” when referring to a wireless multi-screen video gaming system refers to a system set-up wherein the hand controllers 40 are capable of sending wireless signals to the game module 30 and/or the game module 30 is capable of sending wireless signals to the primary monitor 20.

In one preferred embodiment of this invention (not shown), each hand controller 40 can be connected directly with the primary monitor 20. In this embodiment, the primary monitor 20 preferably contains information processing capabilities similar to the game module information processing capabilities discussed above. For example, suitable information processing equipment may be housed within the primary monitor 20 or the game module 30 may be integrated with and/or positioned within the primary monitor 20.

As shown in FIG. 3, the multi-screen video gaming system 10 can be connected to an existing video gaming system platform 100, such as a SONY PLAY STATION, a NINTENDO GAME CUBE and/or a MICROSOFT X BOX gaming system. The additional interfacing and/or communication with an existing video gaming system platform makes the multi-screen video gaming system of the present invention compatible with existing video gaming systems.

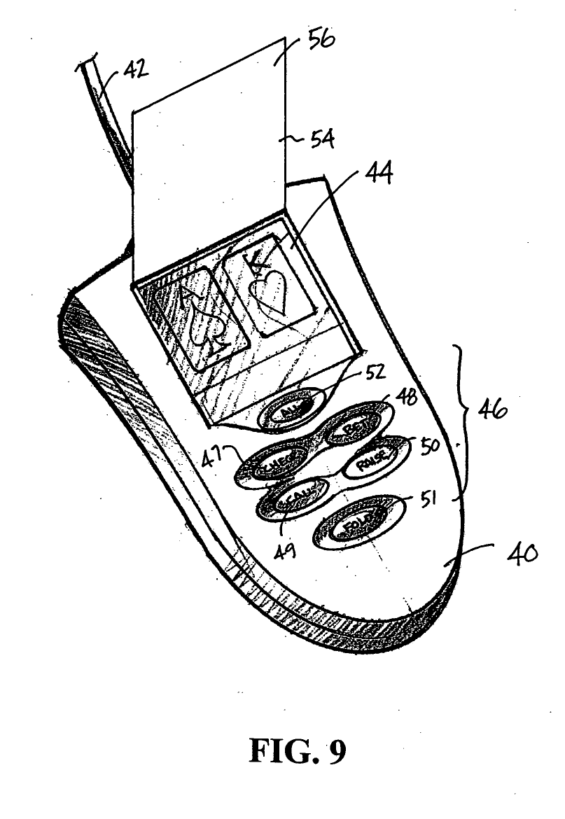

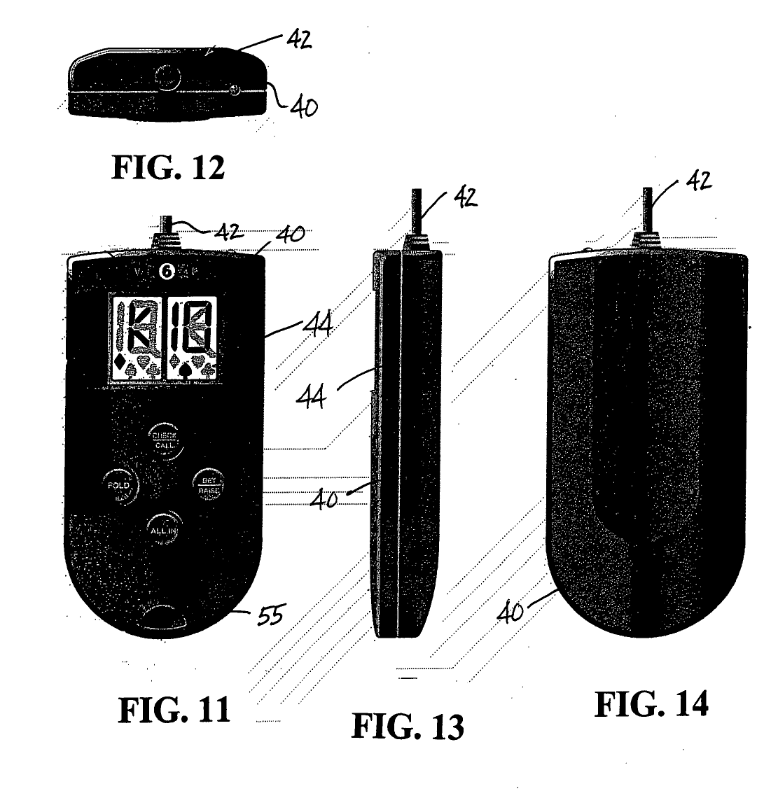

Referring further to FIGS. 1-3 and 7-14, each hand controller 40 preferably includes at least one visual secondary monitor 44. In one preferred embodiment of this invention, each hand controller 40 can receive at least one community signal and/or at least one independent signal transmitted from the game module 30, for example to generate at least one video graphic on the secondary monitor 44. The secondary monitor 44 may be a LCD screen, a lighted LCD screen, a plasma screen or any suitable electronic display device. The secondary monitor 44 may include one or more visual frames for displaying and/or revealing one or more visual graphics. In one preferred embodiment of this invention, each secondary monitor 44 preferably has dimensions of about 4 cm by about 4 cm. It is apparent that each secondary monitor 44 can have any suitable dimension, less than about 4 cm or greater than about 4 cm. Further, it is apparent that each hand controller 40 can have any button or key configuration or layout, shape and/or design configuration.

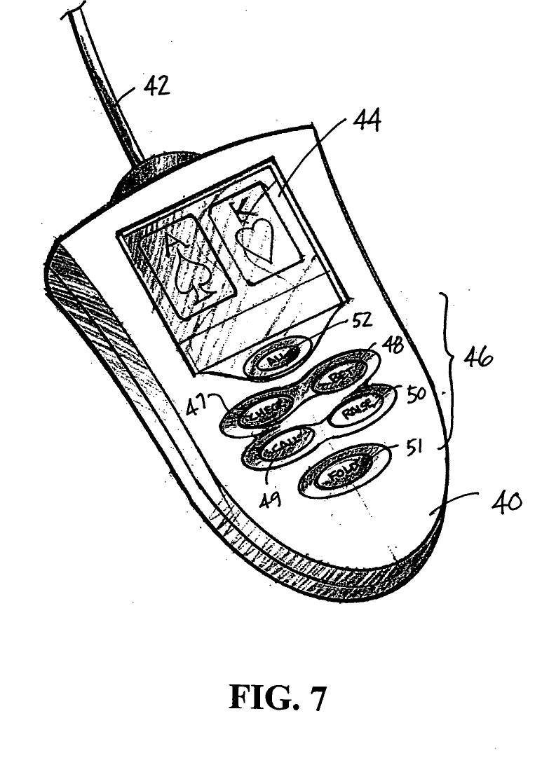

Each secondary monitor 44 displays or reveals at least one private video graphic, such as one player's individual or private hand of cards, and prevents other players from seeing the player's individual hand displayed or revealed on the secondary monitor 44. Additionally, in one preferred embodiment of this invention, each hand controller 40 includes a plurality of buttons or keys 46 associated with selectable actions or decisions for the player to operate or play the player's hand. For example, as shown in FIGS. 7-10, while playing a video “Texas Hold ‘Em” poker game, the player may select and/or press a key 46 to CHECK (key 47), BET a desired amount of money or a desired number of casino chips (key 48), CALL (key 49), RAISE a desired amount of money or a desired number of casino chips (key 50), FOLD (key 51), or put ALL the player's money or casino chips into the hand (key 51). For example, if the player wishes to raise the player's bet after viewing the player's individual hand on the secondary monitor 44, the player can press key 50. By pressing key 50, a command signal is transmitted from the hand controller 40 to the game module 30. The game module 30 then processes the command signal, and the player's current bet showing on the primary monitor 20 is increased to indicate to the other players that he or she has raised his or her bet.

In one preferred embodiment of this invention, the video gaming system 10 may be used to play other video games, such as video Craps, video Blackjack or video Gin Rummy. Each button or key 46 may be associated with a different action or decision when a different game, such as video Gin Rummy, is being played. For example, each game may require dedicated button or key graphics, a graphics card or facie plate having various key names or selections corresponding to keys 46 that can be placed on a top surface of the hand controller 40, depending upon the selected game being played.

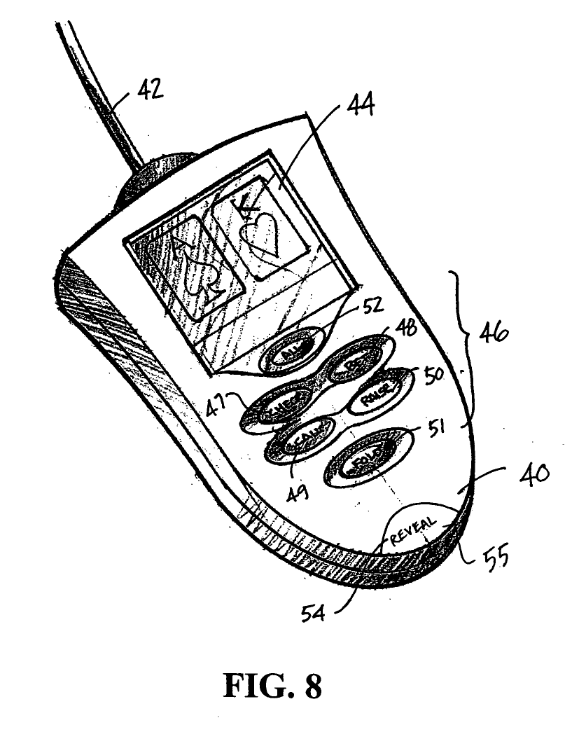

Each secondary monitor 44 allows the player to independently view his or her private hand, without other players being able to view the secondary monitor 44. In preferred one embodiment of this invention as shown in FIGS. 8-10, each hand controller 40 includes a cloaking device 54, such as a hide/reveal button 55. Referring to FIG. 8, the hide/reveal button 55 is initially in an off position so that the visual graphics are not displayed or revealed on the second monitor 44. The player can activate or press the hide/reveal button 55 so that the visual graphics, such as the player's private hand, are temporarily displayed or revealed. Upon release of the hide/reveal button 55 or after a programmed time, the visual graphics will be removed from the secondary monitor 44 or obstructed or covered to prevent viewing of the secondary monitor visual graphics, with the hide/reveal button 55 in the off position.

Alternatively, the cloaking device 54 may include a door 56 or other suitable obstructing member (not shown) which at least partially covers the secondary monitor 44. The door 56 is movable to allow the player to view the visual graphics on the secondary monitor 44, when desired. For example, the door 56 may be hingedly or pivotally attached to the hand controller 40 and when the player wishes to view his or her private hand, the player may manually move the door 56 to reveal the secondary monitor 44 displaying the visual graphics. In one preferred embodiment of this invention, the cloaking device 54 may include a flexible and/or bendable flap made of a rubber material and/or any suitable flexible material that can be flexed or bent to reveal the secondary monitor 44. It is apparent to those skilled in the art and guided by the teachings herein provided that other suitable cloaking devices 54, including mechanical and/or electrical components, may be used to temporarily and/or selectively cover or obstruct viewing of the secondary monitor 44, to prevent other players from viewing the visual graphics displayed thereon.

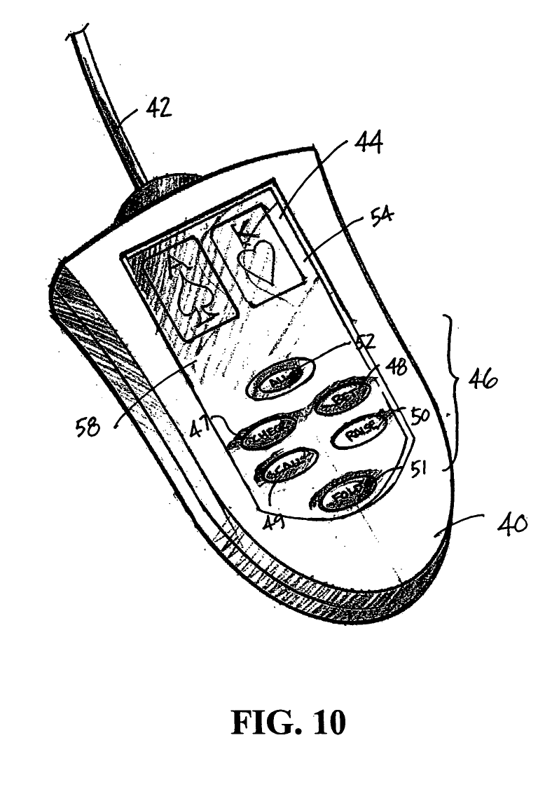

In one preferred embodiment of this invention, the secondary monitor 44 comprises an interface panel 58, such as a lit or illuminated touch screen interface panel. For example, the interface panel 58 may include the player's private hand as well as the plurality of buttons or keys 46, as shown in FIG. 10. Preferably, at least a portion of the touch screen interface panel can be turned on and off, as desired, to reveal or hide, respectively, the player's private hand.

In order to allow play in a dark environment, at least a portion of each hand controller 40 is preferably lit or illuminated. For example, in one preferred embodiment of this invention, the secondary monitor 44 can be back lit to allow the player to view the visual graphics displayed thereon. Additionally or alternatively, each of the plurality of buttons or keys 46 is capable of lighting or sounding to alert or prompt the player that action is required, for example if it is the player's turn to bet. The hand controller 40 may also receive from the game module 30 a communication or transmitted signal including a tactile feedback, such as a vibration.

In one preferred embodiment of this invention, the game module 30 may include a storage compartment for storing the hand controllers 40 when the multi-screen video gaming system 10 is not operating. The storage compartment may be lockable, for example to store bets as the game is being played. Each player may place an entry fee into the storage compartment, and when the game begins, the storage compartment is locked until the game is finished and a winner or champion is declared.

Thus, this invention provides a multi-screen video gaming system for playing video card games for example, that utilizes a primary monitor, such as a television screen or a computer monitor, and a plurality of hand controllers each having a relatively smaller secondary monitor, preferably a LCD screen. The multi-screen video gaming system allows multiple players to play video card games, such as Poker, Gin Rummy, Go Fish, Crazy Eights and Blackjack, using a video game format. The primary monitor displays community cards on a card playing table and any number of secondary monitors each displays or reveals a player's individual or private hand of cards. The multi-screen video gaming system includes a game module that interfaces with the primary monitor and each player's independent hand controller. The multi-screen video gaming system can be conceived as a plurality of independent components, as an all-inclusive video gaming system or any combination thereof.

The present invention is described in further detail in connection with the following example which illustrates or simulates various aspects involved in the practice of the invention. It is to be understood that all changes that come within the spirit of the invention are desired to be protected and thus the invention is not to be construed as limited by this example.

### EXAMPLE

1. GAME MODULE. The game module is the main power source and is the conduit between the primary monitor and the plurality of hand controllers. In one embodiment, the game module has a diameter of about 5.5 inches.
1.1 POWER SWITCH
to turn the game on/off
1.2 SELECT
to select GAME (Elimination Tournament No Limit, Elimination Tournament Limit, Table Stakes, One Player High Score Tutorial Challenge)
to select CHIP COUNT ($100, $500, $1,000, $10,000, $100,000, $200,000) (the BUY-IN automatically changes depending on the chip count)
to select NUMBER OF PLAYERS (up to 6 players at table)
TOURNAMENT SFX (players can choose to play with or without tournament SFX)
1.3 CONFIRM/START p1 to confirm GAME selection
to confirm CHIP COUNT (the Chip Count is the value of chips with which each player begins)
to confirm number of players
to start game once game, chip count, number of players, and SFX have been confirmed and once hand controllers are plugged into the game module (Note that after all selections have been made, an additional summary screen showing all selections will appear on screen. After reviewing the summary screen, a player then presses the START button to begin play. If the player has made a mistake in selection process, repressing the SELECT button will retoggle all selection options)
1.4 SAVE
to save the current game (money totals/chip count for each player at the end of the play session)
1.5 RESET SWITCH*
to reset the game if the unit malfunctions. *This is an optional feature. The game could reset just by pulling out the plug or by holding down the “FOLD” button for five seconds.

2. PLAYER HAND CONTROLLERS. There are preferably 6 hand controllers. All six hand controllers may have the same control format (button positions).
2.1 CHECK/CALL
to CHECK (stay in a hand when no bet has been made and do not wish to bet; a check is not allowed when a bet has been made)
to CALL (to match any bet)
2.2 BET/RAISE
to BET (place the first bet in a round of play)
to RAISE (matching a bet already on the table and raising it)
2.3 FOLD
to drop out of a hand
2.4 ALL IN
to bet all the player's money (Note: A player can always call a bet, but the player can only win as much as he or she has in the pot. If the player loses, the player is out of the game.)
2.5 HOLE CARDS
press to reveal hole cards on player's hand controller (WHITE LED lights as button pressed)
release the button and hole cards disappear (WHITE LED turns off as button released) Note: If the player does not do anything for 90 seconds, the player will temporarily leave the table. To reenter the table, the player presses any control button between hands.

3. HOW TO PLAY: USING THE GAME MODULE
3.1 Turn ON the game module. (VIDEO: ON PRIMARY MONITOR, A SPORTS CAR DRIVING DOWN THE STRIP, THE CAR STOPS IN FRONT OF A CASINO, A SIGN READS “TEXAS HOLD ‘EM TONIGHT”. THE DOORS OF THE CASINO SWING OPEN AND MONEY IS DISPLAYED FLYING AROUND THE ROOM AND GENTLY FALLING DOWN IN A NICE PILE.)
3.2 GAME OPTIONS
game selected, options including chip count, number of players and tournament sound effects selected using the game module
3.3 Press the SELECT button on the game module. (VIDEO: THE PRIMARY MONITOR DISPLAYS THE PROMPT: “USE THE SELECT BUTTON TO SELECT “GAME”)
   3.3.1 Now each time the player presses the SELECT button, a different one of the four games will appear on the primary monitor screen. If player keeps pressing the SELECT button the game selections will keep toggling.
   3.3.2 As each game appears on the primary monitor screen, an explanation for each game also appears on the primary monitor screen, as set forth below:
Elimination Tournament No Limit: There is no limit to the amount the player can bet. When a player runs out of money, he or she is eliminated from play. The last player left is the winning player. Note that any time the same player raises twice or more in a single round, the betting amount automatically doubles. So if it is a $10/$20 game and on the flop (after the first three cards are automatically dealt), one player bets $10 and another player raises him, the first player can come back and raise again, but on his second raise, the bet goes up to $20. Likewise, if the second player who bet wants to raise again, that raise is automatically $40, and if the first player wants to come back and raise again, then that raise is $80. So each time the same player raises WITHIN THE SAME ROUND, the table stakes are automatically doubled. When the next round of play begins, the betting returns to the normal level until a player does a second raise again.
Elimination Tournament Limit: Bets are limited to the buy-in amounts. Since this is still tournament play, when a player runs out of money, he or she is eliminated from play. The last player left is the winning player.
Table Stakes: This is the kind of game friends might play in a friendly Saturday night game. But since this is not tournament play, when a player runs out of money, he or she is not eliminated. Instead, the player's dollar amount goes into the “negative” when the player runs out of money and the player continues to play. So since the player never runs out of money, “ALL IN” feature is not activated in this game.
One Player High Score Tutorial Challenge: This is a one player game; the player against three computer players. The rules of the One player game are the same as Elimination Tournament Limit.
   3.3.3 If player does not toggle for more than 20 seconds, then game will default to “ELIMINATION NO LIMIT” game.
   3.3.4 Once a game selection remains on the primary monitor screen for 10 seconds, next to the “game” shown on the screen will be another screen that reads: “PRESS CONFIRM/START TO CONFIRM GAME.”
   3.3.5 Player now presses the CONFIRM/START button to confirm game choice.
3.4 Primary monitor displays a screen that reads: “USE THE SELECT BUTTON TO SELECT CHIP COUNT.”
   3.4.1 Each time the player presses the SELECT button, a different CHIP COUNT will appear on the primary monitor screen. The Chip Counts (which remain the same for all four games) are: $100, $500, $1,000, $10,000, $100,000, $200,000. When the buy-in screen is shown, the players will also see a pile of chips change. For example, with a buy-in of $20/$40, the players see two $10 chips next to a pile of four $10 dollar chips to show the fact that the buy-in requires $20 bets for the first cards and $40 bets for the last two cards.
   3.4.2 If the player does not toggle for more than 20 seconds, then the default is a $1,000 chip count for each player.
   3.4.3 The player presses the CONFIRM/START button to confirm the buy-in.
3.5 Primary monitor displays a screen that reads: “USE THE SELECT BUTTON TO SELECT NUMBER OF PLAYERS.”
   3.5.1 Each time the player presses the SELECT button, a different number of players will appear on primary monitor.
   3.5.2 In addition, on the primary monitor a poker room with a six chair arrangement is displayed.
   3.5.3 Each time the player presses the SELECT button, a different number of players will toggle on the primary monitor from 2 through 6. On the primary monitor, as the players are being toggled, the words “Player 1”, “Player 2”, etc., may appear as if the words were sitting in one of the six chairs.
   3.5.4 If the player does not toggle for more than 20 seconds, then the default will be 2 players.
   3.5.5 The player presses the CONFIRM/START button to confirm the number of players.
3.6 Primary monitor displays a screen that reads: “TOURNAMENT SOUND EFFECTS YES/NO.”
   3.6.1 Use the SELECTION button to toggle between YES or NO.
   3.6.2 If the player does not toggle for more than 20 seconds, then the default will be YES.

4. HOW TO PLAY: USING THE HAND CONTROLLERS
4.1 Each player can plug in a hand controller. If, for example, a 4 player game has been selected, 4 players can log on by plugging in his or her hand controller. Note that this may be a cost savings and also easier for players than “hot wiring” all the hand controllers into the game module.
4.2 Each time a player logs on a small “power” light on his or her hand controller is activated.
4.3 On the primary monitor, a screen reads: ”______ of ______ players logged in.” For example once 1 player has logged in for a 4 player game, the primary monitor screen will read: “1 of 4 players logged in.”
4.4 Note that in a 4 player game, only 4 hand controllers will be activated, even if more than 4 hand controllers are plugged into the game module. For example, if all 6 hand controllers are plugged in, only 4 hand controllers will be activated.
4.5 Once the correct number of hand controllers have been activated, the dealer will automatically deal the first round of play.
4.6 Depending on which game is selected, the rules are slightly different.
   4.6.1 Elimination Tournament No Limit: There is no limit to the amount a player can bet. When a player runs out of money, he or she is eliminated from play. The last player left is the winning player. Note that any time the same player raises twice or more in a single round, the betting amount automatically doubles. For example, in a $10/$20 game, on the flop (after the first three cards are automatically dealt), if one player bets $10 and another player raises him, the first player can come back and raise again, but on his second raise, the bet goes up to $20. Likewise, if the second player who bet wants to raise again, that raise is automatically $40, and if the first player wants to come back and raise again, then that raise is $80. Each time the same player raises WITHIN THE SAME ROUND, then the table stakes are automatically doubled. When the next round of play begins, the betting returns to the normal level until a player does a second raise again.
   4.6.2 Elimination Tournament Limit: Bets are limited to three raises on each card. Since this is still tournament play, when a player runs out of money, he or she is eliminated from play. The last player left is the winning player.
   4.6.3 Table Stakes: This is the kind of game friends might play in a friendly Saturday night game. Bets are limited to three raises on each card. But since this is not tournament play, when a player runs out of money, he or she is not eliminated. Instead, before the next round begins, he or she is given an additional $10,000 by the bank—and EACH player in the game is also awarded an additional $10,000 by the bank. The winning player is the player with the most money when play is stopped.
   4.6.4 One Player: One player against three computer players. The rules of the One player game are the same as Tournament Limit. Before play begins, the player can toggle the skill level of the game.
4.7 Each player begins play with $1,000. By each player throughout the game, the primary monitor will display the player's chip count next to the chair where the player is sitting.
4.8 The Button: On the primary monitor a “button” is displayed. The button is a little white disk that looks like a hockey puck, preferably reading “DEALER.” The puck moves around the table each time a hand is played, and indicates which player is actually the dealer for that hand. Note that the dealer gets his or her cards last and acts last in each betting round. In Texas Hold ‘Em positioning may be important in each hand.
   4.8.1 In the first hand of the day, the dealer button will move around the table twice and then randomly stop on one player to determine which player deals first.
4.9 Small Blind and Big Blind
   4.9.1 Small Blind: In each hand, as the cards are dealt, the player to the immediate left of the dealer can automatically put a “small blind” in the pot. The small blind is half the amount of the bet on the first card. So in a $20/$40 game, the small blind automatic bet is $10. Note that if it is a $5/$10 game, the small blind is a $2 bet. This is the only example of when the small blind is not exactly half the amount of the initial bet.
   4.9.2 Big Blind: In each hand, as the cards are dealt, the player to the immediate left of the player who makes the small blind automatically puts a “big blind” in the pot. The big blind is the same amount as the initial bet. So in a $20/$40 game, the big blind is an automatic $20 bet. In a $5/$10 game, the big blind is an automatic $5 bet.
4.10 Timer: There is a 30 second timer positioned at a top portion of the primary monitor screen above the casino table. When it is a player's turn, he or she has 30 seconds to make his or her decision.
4.11 Penalty Points: If a player does not take his or her turn (make a decision) within 30 seconds, he or she is assessed a penalty point. On the bottom of the primary monitor screen, will appear for example “Player 1 now has 1 penalty point,” or “Player 2 now has 2 penalty points.”
4.12 Auto Folding: If a player does not do anything for more than 60 seconds, he or she automatically folds.
4.13 Auto Leaving Table: If a player does nothing at the table for 90 seconds, he or she will temporarily be dealt out of hands. To reenter play, the player touches any hand controller button between hands to reenter.
4.14 Winning Hands: After a hand is complete, the winning hand is highlighted on the primary monitor screen. In addition to the five winning cards being highlighted, along a bottom portion of the primary monitor screen (preferably in the same screen area that penalty points are displayed), the winning hand is described, for example, “PLAYER 1 WINS WITH TWO PAIR, ACES OVER TENS.”
4.15 At the beginning of each hand, the dealer, starting at his left, deals so that each player has two cards face down. These are the hole cards.
4.15.1 On the primary monitor screen, a closeup of the dealer's hands dealing the cards is displayed. The cards should look like they are being flipped out of the dealer's hand and are flying directly out of the primary monitor screen in a very tight ECU CAMERA SHOT.
4.15.2 SFX: A sound effect is heard as each of the hole cards leaves the dealer's hand on the primary monitor screen and settles into the player's hand controller.
4.16 The HOLE CARD button on the base of the hand controller is pressed to reveal the player's two hole cards. As the HOLE CARD button is pressed, the cards will reveal themselves and the WHITE RED LED above the LCD screen on the hand controller will shine, illuminating the cards, even if the players are playing in the dark.
4.17 On the primary monitor screen, when a player checks his or her hole cards, the view on the primary monitor screen shows a closeup (CU) of a player's hands checking his or her hole cards. On the primary monitor screen, a hand fanning out the two cards is displayed but the actual card values are not revealed on the primary monitor screen.
4.18 There is one round of betting on these first two cards. Each time a player presses the BET/RAISE button, he or she bets the buy-in.
4.19 Note that the players can either CHECK/CALL, BET/RAISE or FOLD on every card.
4.20 Sometimes a player will press FOLD even though no bet has been made. That's a wrong decision, because pressing CHECK costs nothing. Along the bottom of the primary monitor screen, when the player presses FOLD in this instance, the primary monitor screen should read: “ARE YOU SURE? IT COSTS NOTHING TO CHECK AT THIS TIME.” Then player has additional opportunity (30 seconds) to change from FOLD to CHECK.
4.21 Capping: The betting is capped after betting has gone completely around the table twice. To go completely around the table twice means that each player has the opportunity to make two raises. Note that in the No Limit game, there is no capping, so as long as two players want to keep raising back and forth, they can.
4.22 After the first round of betting, the dealer now deals three consecutive cards face up in the middle of the table. These three cards are shown on the primary monitor screen. These cards are called the “flop” and are community cards used in common by every player still in the hand.
4.23 Now there is a second round of betting. Bets remain in the initial buy-in increment.
4.24 After that, a fourth card is dealt face up on the primary monitor screen and a third round of betting occurs. But on the fourth up card, betting increases to the back end of the buy-in. For example, in a $10/$20 game, while betting would be in $10 increments on the first three “up” cards, beginning with this fourth card and continuing through the fifth and final card, bets are in $20 increments.
4.25 The fifth and final card is then turned up in the community cards on the primary monitor screen. A last round of betting takes place. In this final round of betting, the betting increment remains the same as on the fourth community “up” card.
4.26 If there is more than one player left in the game at the end, the winner of the pot is the player with the best poker hand using the best five out of seven cards (the two in his hand and the five in the middle).
4.27 Split Pots: There are two ways to have a split pot.
   4.27.1 A split pot occurs sometimes-but very rarely-when two players have exactly the same hand. For example, two pair: Aces over 10s, with the fifth card being a 7 for both players. In this case, the two winning players split the pot.
   4.27.2 The second way a split pot occurs is when a player runs out of money and presses his or her ALL IN button during tournament play. A player can only win as much money that he or she actually bet. So while a player can finish a hand, even if he or she is out of money, additional money can be bet without him or her. Then a second pot will begin to build on primary monitor screen. The second pot can be shown building on the primary monitor screen as well. Then if the player who did “ALL IN” wins the hand, the player with the second best hand only wins what he bet—and the player with the second best hand will win the split pot money.
   4.27.3 If a different player wins the hand (not the player who played as ALL IN) then this second player wins the ENTIRE pot—because this player participated in all rounds of bets.
4.28 “Check” and “Raise” is allowed. This is called “sandbagging.” So a player can check, then when another player bets, the player who checked is allowed if he desires, to not only call the bet but raise it back.
4.29 After each hand is complete, the primary monitor screen will revise each player's chip count.
4.30 LEVELS: The betting amounts will gradually increase as play continues. Of course, see spec 4.32 below to see where the buy-ins begin for each Chip Count. After each 30 hands are played, the buy-in amounts will increase to the next level. After the $2000/$5000 level is achieved, there is just one more level 30 hands later, which is $5000/$10,000. That is the highest level that can be attained and level remains there.
4.31 Believing that sometimes players will use real money in the Table Stakes Game, the levels will not automatically increase in the Table Stakes game.
4.32 The Buy-ins are set depending on the Chip Count: $100, $500, $1,000, $10,000, and $100,000.
4.32.1 When the Chip Count is $100, then the buy-ins are $5, $10.
   4.32.2 When the Chip Count is $500, then the buy-ins are $20, $40.
   4.32.3 When the Chip Count is $1,000, then the buy-ins are $50, $100.
   4.32.4 When the Chip Count is $10,000, then the buy-ins remain $100, $200.
   4.32.5 When the Chip Count is $100,000, then the buy-ins are $1000, $2000.
   4.32.6 When the Chip Count is $200,000, then they buy-ins are $2,000, $5000.

5. PRIMARY MONITOR AND SECONDARY MONITOR VIDEO SCREENS. Throughout play, preferably interesting video appears on the primary monitor screen and/or the secondary monitor screens. The above specs include suggested or preferred written text for the screens. Here the suggested or preferred visual graphics are described.
5.1 First Screen: Show brand logo, product name, Copyrights, ownership, date and all rights reserved statement, etc. (displayed for about 3 seconds).
5.2 Introduction Screen, Music and Lights displayed for about 10 seconds (with option to skip intro by pressing ENTER button)
5.3 Game Set-up Screen(s)
   5.3.1 Game: Elimination Tournament NO LIMIT Game, Elimination Tournament LIMIT Game, Table Stakes Game and One Player High Score Tutorial Challenge.
   5.3.2 Number of Players: 1, 2, 3, 4, 5 or 6?
   5.3.3 Chip Count Purchase: $100, $500, $1000, $10,000, $100,000, $200,000. Note: levels automatically tie into chip purchase amount: 5-10, 20-40, 50-100, 100-200, 1,000-2,000 or 2,000-5,000, and will be shown on summary page accordingly as paired with game.
   5.3.4 Tournament sound effects option: Yes/ No?
5.4 Tournament SFX will include:
A. Crowd cheer (3 levels based on pot win performance)
Heavy Cheer (shouting, whistling and clapping)
Medium Cheer (whistling and clapping)
Light Cheer (clapping)
B. Commentator remarks
C. Bomb Blast with smoke puff visual on chair when player is eliminated.
D. Celebration Tune on Game Closure Screen
   5.4.1 Note that table SFX will always be active, regardless of Tournament sound effects option, and include:
cards being dealt sound
chip stacking sound (chip rattle sound)
knocking sound, for when player checks
chime sound when player raises
multiple chime sound when winning hand is highlighted
5.5 Summary: Game, Players, Chip Count Purchase, Level and Tournament sound effects option. Begin? (Prompt)
5.6 Main Table Layout (Note follow-up with wide screen format adaptation)
   5.6.1 Header Strip “Tote” Information: Game, Level, Hand #, 30 sec. Clock, Total Chip Purchase Amount $6,000 and Individual Chip Purchase Amount $1,000
5.7 Prompts on bottom right corner of main screen can tell each player what to do. Example: check, bet, call, raise, or fold. Prompts will be copy stacked in corner, prompts will high light when selected by player pushing hand set button.
5.8 Hand winner recap area at bottom of primary monitor screen. For example, “Player 4 wins with two Aces and two 10s.”
5.9 Main Table shot with animated details through game play.
   5.9.1 Dealer button cycles around 2 times (quickly making “beep beep” sound) and lands on random occupied seat to begin game. This only happens 1 time at each game start.
5.10 Hole cards: when a player examines his or her hole cards on hand controller, the cards on the primary monitor game screen twitch or animate accordingly. This way, like real poker, players can read each other's movements for a possible “tell.”
5.11 In turn, a player's number blinks on the corresponding chair or the chair is highlighted.
5.12 A SMALL BLIND graphic lights up and a chip is automatically placed then the process happens again with a BIG BLIND graphic.
5.13 The beginning bet cycle continues and chips are placed in front of the cards accordingly.
5.14 Once the first betting cycle is completed, the chips move from each player's area to a table pot located near the community cards. A money value of chips in the pot is displayed next to the chip stack. This same animation preferably happens through all betting cycles.
5.15 If a player folds a hand then the words OUT appear accordingly.
5.16 All active player hands are exposed at the end of the last betting cycle along with the 5 community cards. A winning hand is highlighted along with the specific community cards that make the best hand.
5.17 Preferably, but not necessarily, when a player is eliminated, a bomb blast (sound effect) goes off and a puff of smoke is seen at the player's chair. The chair is then darkened to indicate that the player has been eliminated from the game.
5.18 Note for Table Stakes Game: a player can press the FOLD button for 5 seconds to exit the game at any time (with a screen prompt verifying the player's action: “Exit Game? If so, hit Fold again.”). . . then the player is officially out.
   5.18.1 After a second to last person is out, the viewer's reference tote screen results.
5.19 The bank amount for each player (whether in or out) is always posted on the game chair during a live game.
5.20 Leader Board “chip leader highlight” Screen: a leader board is posted after every 10 hands are played or when there is a big swing in chip count based on any particular hand.
5.21 Closure Screens (winner's celebration)
   5.21.1 “Tournament No Limit Champion” (Player #1 Wins $100,000)! Leader Board screen appears with winner header.
   5.21.2 “Tournament Limit Champion” (Player #1 Wins $10,000)! Leader Board screen appears with winner header.
   5.21.3 “Table Stakes Champion” (Player#1 wins $6,000)! After a second to last person is out, viewers reference the Leader Board screen. Also, the bank amount for each player (whether in or out) is always posted on the game chair during a live game.
   5.21.4 “High Score Challenge” (ABC $1,000), (DEF $950), (HIJ $700) and so on. One player tote screen leader board: with option to type player's initials (ABC). Note that the money amount will appear and rank the leaders initials accordingly.
5.22 SFX option: offer short celebration tune or loop sound track, about 7 seconds.
5.23 Play Again Screen
   5.23.1 Same as summary page for game start with the words: “Play again?”
   5.23.2 Users have an option to keep as is; any player can press START/ENTER to repeat similar game.
   5.23.3 The nest game can be modified accordingly with the SELECT button, starting from the top and working through, like original game set-up sequence.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

1. A video gaming system comprising:
a game module operatively connectable to a primary monitor having a first screen for displaying at least one community video graphic; and
a plurality of hand controllers, each hand controller of the plurality of hand controllers in independent operational communication with the game module, and including a secondary monitor for displaying at least one private video graphic.

2. The video gaming system of claim 1 wherein the game module interfaces with the primary monitor and each hand controller.

3. The video gaming system of claim 1 wherein the game module is wired to the primary monitor.

4. The video gaming system of claim 1 wherein the game module is in wireless communication with the primary monitor.

5. The video gaming system of claim 1 wherein the game module further comprises a port for accepting software.

6. The video gaming system of claim 1 wherein each hand controller is wired to the game module.

7. The video gaming system of claim 1 wherein each hand controller is in wireless operational communication with the game module.

8. The video gaming system of claim 7 wherein the wireless operational communication comprises at least one of infrared signals, radio control signals, data transfer signals and BLUE TOOTH technology signals.

9. The video gaming system of claim 1 wherein each hand controller further comprises a plurality of command buttons, each command button transmitting a selectable command to the game module.

10. The video gaming system of claim 1 wherein each hand controller further comprises a cloaking device activatable to reveal the private video graphic.

11. The video gaming system of claim 10 wherein the cloaking device comprises a hide/reveal button, a door or an interface panel.

12. The video gaming system of claim 1 wherein at least a portion of each hand controller is illuminatable.

13. The video gaming system of claim 1 wherein the game module is portable.

14. A video gaming system including a primary monitor for displaying at least one community video graphic, the video gaming system comprising:
a portable game module operatively connected to the primary monitor; and
a plurality of hand controllers, each hand controller of the plurality of hand controllers in independent operational communication with the game module, and including a secondary monitor for displaying at least one private video graphic, wherein each hand controller includes a cloaking device activatable to reveal the at least one private video graphic.

15. The video gaming system of claim 14 wherein the cloaking device comprises a hide/reveal button.

16. The video gaming system of claim 15 wherein the hide/reveal button is movable between an initial off position to an on position to temporarily reveal the at least one private video graphic.

17. The video gaming system of claim 14 wherein the cloaking device comprises a door pivotally connected with respect to the secondary monitor, and pivotally movable between a closed position and an open position to reveal the at least one private video graphic.

18. The video gaming system of claim 14 wherein the cloaking device comprises an interface panel, wherein at least a portion of the interface panel can be turned on to reveal the at least one private video graphic and turned off to hide the at least one private video graphic.

19. The video gaming system of claim 18 wherein the interface panel further comprises a plurality of command buttons, each command button selectable to transmit a command to the game module.

20. The video gaming system of claim 18 wherein the interface panel comprises a touch screen interface panel.

21. The video gaming system of claim 14 wherein each hand controller further comprises a plurality of command buttons, each command button selectable to transmit a command to the game module.

22. A video gaming system comprising:
a primary monitor having a first screen for displaying at least one community video graphic;
a portable game module operatively connected to the primary monitor, the game module transmitting at least one signal to generate the at least one community video graphic; and
a plurality of hand controllers, each hand controller of the plurality of hand controllers in independent operational communication with the game module, and including a secondary monitor for displaying at least one private video graphic, wherein each hand controller includes a cloaking device activatable to reveal the at least one private video graphic and a plurality of command buttons, each command button selectable to transmit a command to the game module.
